(19) United States
(12) Patent Application Publication
(10) Pub. No.: US 2007/0174481 A1
(43) Pub. Date: Jul. 26, 2007

(54) Method of optionally transferring information

(75) Inventors: Bertil Damberg, Saltsjo-boo (SE); Tomas Ostlund, Kista (SE)

Correspondence Address: ALFRED J MANGELS, 4729 CORNELL ROAD, CINCINNATI, OH, 452412433, US

(73) Assignee: AIRNET HOLDING AB, KISTA (SE)

(21) Appl. No.: 10/550,746

(22) PCT Filed: Feb. 2, 2004
(86) PCT No.: PCT/SE04/00129

§ 371 Date: Dec. 22, 2006

(30) Foreign Application Priority Data
Mar. 25, 2003 (SE) 0300827-3

(51) Int. Cl. G06F 15/173

(52) U.S. Cl. 709/238

(57) ABSTRACT

A method of rapidly sending large volumes of information to one or more personal computers from a database containing information. A personal computer is connected to the database via a first communication network, such as the Internet, to a server connected with the database to allow a user to request information. A second communication network, such as a DAB radio network, transmits requested information from the server at high speed to a receiver unit in the possession of the user. A proxy server between the personal computer and the server selectively either forwards collected information for transmission to the receiver unit via the digital radio network, to allow information received in the receiver unit to be transferred to the personal computer, or, alternatively, to allow the direct transfer of information between the server and the personal computer.

### BACKGROUND OF THE INVENTION

1. FIELD of the Invention

The present invention relates to a method of transferring large volumes of information to a personal computer or to some corresponding device.

2. Description of the Related Art

One problem with the transmission of large volumes of information to a personal computer or to some corresponding device, and then particularly to a personal computer that can be connected to a given company or to a database via a modem, is that the transmission of such information to the personal computer takes a relatively long time to carry into effect. This means long connection times and long response times in respect of the information desired by the user.

One example in this regard is Internet shopping, so-called network commerce. When a person wishes to do business over the Internet with a company that has a very large assortment of goods that are also illustrated pictorially or graphically, the total amount of information to be transferred will be extremely large, even though the information relates solely to a certain group of goods, such as to clothes or furniture for example.

Another example resides in a user wishing to download a large file of some other kind, such as a music file, a film file, or software.

The problem is thus that the transmission of such information from the company to the user takes too long.

Another problem is that the user must remain connected to the company during the time taken by the user in selecting the goods desired, for instance clothes. In addition to the time taken in sending the actual information, the time during which the user must remain connected during the process of goods selection is also very long.

These problems are solved by the present invention.

### SUMMARY OF THE INVENTION

The present invention relates to a method of sending large volumes of information to one or more personal computers or corresponding devices from a database or the like. An example is the product line of a company stored in connection with the company's home page or a portal, wherein the personal computer can be connected via a communications network, such as the Internet, to the database, which includes a computer in the form of a server. The database includes the information and a user is able to ask for information via the personal computer during this connection. A digital network that has a high transmission rate, such as a so-called DAB radio network, can send the requested information. The information is received by a receiver to which the user has access. The requested information held in the database is given an identification code, which is transmitted to the receiver, and the receiver analyzes the received DAB signal with respect to the identification code. A so-called proxy server is provided between the personal computer and the server to either forward the information collected to the transmitter means for transmission of the information via the radio network, so that this information can be received in the receiver or, alternatively, to be transparent for the exchange of information between the server and the personal computer. When the proxy server is chosen to transmit the requested information from the server via the network to the receiver in response to a request for certain information to the personal computer from the server, the proxy server fetches the information from the server and checks that the information is complete, i.e., that all information packets have been obtained. The proxy server stores the fetched complete information and forwards the information to the transmitting means.

### BRIEF DESCRIPTION OF THE DRAWING

An exemplifying embodiment of the present invention will now be described in more detail partly with reference to the accompanying drawing, in which

FIG. 1 is a block diagram that illustrates the invention.

### DESCRIPTION OF THE PREFERRED EMBODIMENTS

Although the invention is described below with reference to network commerce or network shopping in respect of a company that has a very wide assortment of products, it will be understood that the invention may also concern the transmission of some other form of information where a user requires large volumes of information through which to sort, choose, or order goods or services.

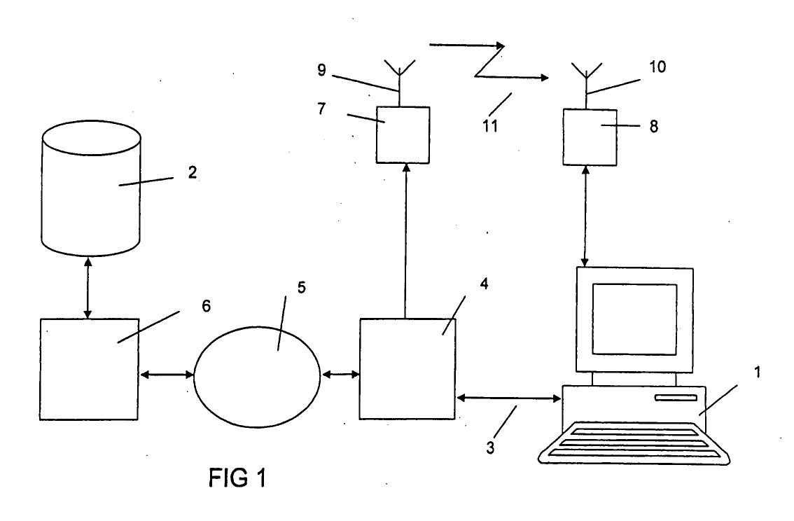

FIG. 1 illustrates a method of sending large volumes of information to a personal computer or some corresponding device from a database 2, or the like, such as a database containing a company's product line stored in connection with the company's home page or a portal . The personal computer 1 can be connected via a communications network 5, such as the Internet, to a computer in the form of a server 6 that includes database 2 that contains the information. A user can request information via the personal computer 1 during the connection.

A proxy server 4 ensures that requested information contained in the database 2 is given an identification code, which is sent to the receiver 8. The identification code is conveniently sent to the personal computer 1 via the communications line 3, and from there to the receiver 8.

The personal computer 1 is connected to a communications line 3 through the medium of a modem or some corresponding device.

The receiver 8 analyzes a received DAB signal 11 with regard to the identification code. Requested information is sent to the receiver 8 by the server 6, via the proxy server 4 and via a DAB network. The receiver 8 starts to receive the information after the identification code has been received by the receiver 8. Actual reception of the information takes place in the absence of an active communications link between the personal computer 1 and the server 6. There is thus no interaction between the personal computer 1 and the server 6 during the reception of the information. The information thus received is then sent from the receiver 8 to the personal computer 1.

The transmission rate via a DAB radio network may, at present, be as high as 1.5 Mbits/s. This enables a very large volume of information to be sent from the database 2 to the personal computer 1 in a very short time interval.

When downloading from the Internet, normal procedure includes continuously checking that the packets into which a data file has been divided reach the correct address. Consequently, there is required a two-way connection, such as between the personal computer 1 and the server 6, during the entire downloading process.

According to the present invention, only the DAB network is used during the actual transmission of the information, wherein the system in this mode consists of a one-way connection between the DAB transmitter 7 and the DAB receiver 8 in the absence of any influence from a connection between the user's computer and the database. However, it may be necessary to switch on the personal computer 1 in connection with the DAB transmission, in order to check that all information-containing packets have been received, and if that is not the case to search for missing packets.

A further server 4, the so called proxy server, is therefore provided between the personal computer 1 and the server 6 in accordance with the invention. When a request for certain information is made from the personal computer 1 to the server 6, the proxy server 4 fetches that information from the server 6 and checks that the information is complete, in other words that all information-containing packets have been obtained. The proxy server 4 stores the complete information fetched from the server 6.

The proxy server is also adapted to selectively either send the fetched information to the transmitter 7 for transmission of the information such as to enable it to be received in the receiver 8, or, alternatively, to be transparent for an exchange of information between the server 6 and the personal computer 1.

The choice as to how the information is to be forwarded can be made from at least the personal computer 1.

This choice is made prior to the information being collected from the server 6 to the proxy server 4.

Since the information to be fetched from the server 6 has been specified to the proxy server 4, the personal computer 1 need not be in operation when the choice is made to transfer the information to the personal computer 1 via a DAB transmission. The two-way communication required between two communicating computers thus only takes place between the server 6 and the proxy server 4.

The proxy server 4 may be placed anywhere that is appropriate, such as in a company location that provides computer services or an Internet operator.

The technology required to transfer information from one computer 6 to another computer 1 by means of DAB techniques is described in Swedish Patent Specification No. 9704101-6.

In brief, the invention described in that patent specification involves the intermediate storage of information from a transmitting computer prior to the transfer by a DAB transmission of the information via a DAB transmitter, wherein the information is transferred generally continuously. The information is received by a DAB receiver and is stored intermediately in the receiver prior to being sent to a receiving computer.

Transmitter 7 and receiver 8 are equipped with respective antennas 9, 10.

In addition to a DAB transmitter, the transmitter means 7 includes in this case the circuits required for receiving information from the server 6 via the proxy server 4, for intermediate storage of the information, and for the transmission of the information. Correspondingly, the receiving means 8 includes circuits for receiving the transmitted information, for the intermediate storage thereof, and for its transmission to the personal computer 1.

Because the information is broadcast, it is possible for an unlimited number of different receivers, or at least a large number of different receivers, to receive the information simultaneously. In order for this technique to be utilized effectively, it is therefore beneficial for several receivers to receive the same information at one and the same time.

According to one preferred embodiment, the information requested is sent at certain times, or as soon as possible. According to another embodiment, when information has been requested by the personal computer 1, the proxy server 4 sends a message to the personal computer as to when the information will be sent.

Taking Internet shopping as an example, a person is able to connect herself/himself to a company's home page via her/his personal computer, modem, etc., and look through the commodities offered by the company. The transmission of a total overview of the goods available with respect to furniture, for instance, illustrated with pictures, would take too long during the connection to be an attractive option. The present invention enables the person to ask to be sent the company's entire catalogue, for instance. The person may then be informed that the catalogue will be sent at a certain time of the day. All that the person need do is to ensure that the receiver 8 is switched on at that time of the day.

When the information has been received and stored in the personal computer 1, the person is able to study the various pieces of furniture in peace, without being connected to the company concerned. The person is therewith able to choose the furniture desired and then connect to the company and place his/her order.

It is obvious that the different commodities or goods on offer can be looked through more quickly when these commodities are downloaded into the personal computer. Moreover, the person need not be connected to the company during the whole of the period in which the commodities are studied, resulting in lower costs.

According to another preferred embodiment of the invention, the information to be sent is given the form of an information block that includes a request for specific information. For example, the person concerned may not wish for all information to be sent. For instance, the information in question may relate to travel information where the person is interested solely in a given region, such as Mediterranean countries. In this example, a travel agency may send information covering different areas at different times and send the entire travel offer at other times. Because the inventive method enables large volumes of information to be transmitted, the amount of information that can be sent concerning a given holiday destination or holiday resort is far greater than that which can be included in a travel brochure.

In addition to network shopping or network commerce of the above-described kind, the inventive method may also be applied in the transmission of news, e.g., in the form of newsprint, in the above-described manner. The invention is not restricted to the transmission of any particular sort of information.

It will be evident that the present invention solves the problems mentioned in the introduction.

Although the invention has been described with reference to a number of exemplifying embodiments, it will be understood that the present invention can be applied with a transmission system other than a DAB system, provided that the system is a rapid digital broadcasting system. Another such system may be a satellite-based system.

It will therefore be understood that the present invention is not restricted to the above-described exemplifying embodiments thereof, but that variations can be made within the scope of the accompanying claims.

What is claimed is:

1. A method of sending large volumes of information to one or more personal computers or corresponding devices from a database or corresponding device, such information as a company's product line stored in connection with the company's home page or a portal, said method comprising the steps of: connecting a personal computer via a first communication network to a server operatively connected with a database, wherein the database contains information that can be requested by a user by way of the personal computer during a connection over the first communication network; providing a second, digital radio communication network having a high transmission speed and including a transmitter unit and a receiver unit, wherein the transmitter unit is connected with the server to receive and transmit requested information, wherein transmitted information is received by a receiver unit in the possession of the user; providing requested information that is contained in the database with an identification code that is sent to the receiver unit to allow the receiver unit to analyze a received, digitally transmitted signal with regard to the identification code; providing a proxy server connected between the personal computer and the server and also between the server and the transmitter unit; transmitting from the proxy server collected information to one of the transmitter unit for transmission of the information via the second, digital radio communication network so that the information can be received in the receiver unit, and to the personal computer via the first communication network; and wherein when transferring requested information from the server via the second communication network to the receiver unit via the proxy server in response to a request for certain information to be transmitted to the personal computer from the server the proxy server fetches the requested information from the server and checks that the information is complete, stores complete collected information, and forwards the information to the transmitter unit.

2. A method according to claim 1, including the steps of: transmitting requested information from the server to the receiver unit via the second, digital radio network and without a direct communication link from the personal computer to the server; and sending the requested information from the receiver unit to the personal computer.

3. A method according to claim 1, including the step of selecting an information transmission network for transmitting requested information between the server and the personal computer prior to sending requested information from the server to the proxy server.

4. A method according to claim 1, including the step of transmitting requested information in the form of an information block that includes specific information requested by the personal computer.

5. A method according to claim 1, including the steps of: transmitting requested information at one of given time points and as soon as possible; and sending from the proxy server to the personal computer a message as to when information requested by the personal computer will be sent.

6. A method according to claim 1, wherein the second, digital radio communication network is a DAB radio network.

7. A method according to claim 1, wherein the first communication network is the Internet.
